(19) United States
(12) Patent Application Publication
(10) Pub. No.: US 2009/0164553 A1
(43) Pub. Date: Jun. 25, 2009

(54) Method and apparatus of accessing network storage device from different private networks through instant messenger

(75) Inventor: Hua-Lung Chiu, Hsinchu (TW)

Correspondence Address: BACON & THOMAS, PLLC, 625 SLATERS LANE, FOURTH FLOOR, ALEXANDRIA, VA, 22314-1176, US

(73) Assignee: Alpha Networks Inc., Hsinchu (TW)

(21) Appl. No.: 12/076,467

(22) Filed: Mar. 19, 2008

(30) Foreign Application Priority Data
Dec. 19, 2007 (TW) 096148697

(51) Int. Cl. G06F 15/16

(52) U.S. Cl. 709/202

(57) ABSTRACT

This invention is a method and an apparatus of accessing a network storage device in different private networks through an instant messenger, which is applied in a network system having a first private network including at least one NAT router and at least one computer, a second private network including at least one NAT router and at least one network storage device, the Internet, and an instant messenger server installed with an instant messenger system. The computer and the network storage device are connected to the instant messenger server by the NAT router of the private network via the Internet. The method installs an instant messenger application program on the computer and the network storage device, so that both of them can use the instant messenger application program to login to the instant messenger server, and communicate with other computers logined to the instant messenger server for files transfer.

### FIELD OF THE INVENTION

The present invention relates to a network storage device, and more particularly to a method and an apparatus enabling a network storage device to register to an instant messenger server provided by an Internet service provider (ISP) via the Internet and enabling a computer to login to the instant messenger server and use a communication mechanism of an instant messenger to access the data file stored in the network storage device.

### BACKGROUND OF THE INVENTION

As computer and communication technologies advance rapidly, Internet service providers (ISP) attempt to use a public network to carry voice, data and video messages for services of their business. In a new generation network system, Internet service providers (ISP) provide different network services including voices, data and multimedia through a telecommunication service network, and focus on the separation of the application services from the transmission technologies to achieve an effect of using all application services without being limited by a particular transmission technology. In other words, the new generation network is a service-oriented network that separates services from calling controls and services from carrying, so that the services are independent from the network in order to provide application services more flexibly and effectively. Regardless of a network such as a telecommunication network, a computer network and a cable television network, the present information network is not the only basic platform, and services with features different from the original information network are developed. As IP technologies are developed rapidly in recent years, a telecommunication network (including cable and wireless networks), a computer network and a cable television network are integrated into a three-in-one network by the advanced IP technology. Further, a mobile communication networks is further integrated to form a four-in-one network, and the IP protocol allows various different types of IP-based services and businesses to communicate with each other over different networks.

A core carrying network and a wideband connection of the new generation network system are built on the present existing IP network infrastructure, and each user needs to have a fixed IP address. However, the Internet is developed so fast, and the space for IP addresses is exhausted quickly in the actual practice, and thus many corporate networks and local area networks need to set up a network address transfer (NAT) at the exit of each network to solve the aforementioned problem. NAT is an Internet standard defined by the RFC 1631 and basically installed in a router and at the boundary of the private network and the public network for converting the IP address of a packet transmitted from a network terminal of a private network, such that several different network terminals in a private network can share the same public IP address for connecting the Internet. In other words, when a private network sends an IP data packet to a NAT device, the NAT is responsible for converting the private IP address of the internal private network into a legal public IP address of a public network. After a data is transmitted from the outside to the NAT device, the NAT checks the information stored in a lookup table, converts the address of a public network into the address of a private network, and transmits the converted address to an internal receiving node.

In general, the NAT device only converts an IP address and a port number of a data packet only. As to the protocols such as the H.323, the session initiation protocol (SIP) and the media gateway control protocol (MGCP) of the instant messenger, actual media connection information is transmitted via the data packet, and thus causing the following problems. Assumed that after a terminal A calls a terminal B and the calling information of the terminal A is transmitted to the terminal B, the terminal B will obtain the IP address of the dedicated network of the terminal A from the data packet based on the H.323 or SIP protocol and attempt to establish a real-time transport protocol (RTP) connection with the terminal A. Since the IP address is a private IP address unidentifiable by a public network, therefore a communication connection cannot be established between the terminals A and B. To improve the security of an intranet, most corporations install a firewall at the entrance and exit of their networks to restrict the type and the flow of a data packet that enters into the intranet. Since both voice and video frequency communication protocols of an IP requires an IP address and a port number between the terminals in order to establish a data communication channel, therefore a dilemma occurs. Each terminal of the new generation network system has to detect an external call at all time, but the firewall does not allow any unexpected data packet. As a result, a certain mechanism is required to open a port of the firewall and transmit a call from an external network to a terminal in the network. However, the RTP/real-time transport control protocol (RTCP) in voice and video frequency communications transmits or receives media through a dynamically allocated port, and thus the firewall issue is an inevitable problem in the actual development of a new generation network system.

In recent years, a network storage device is developed with the new generation network system, and the network storage device is connected to a private network for providing a data access/backup service on a private network. Based on the consideration of security, if the private network is connected to the Internet, the network storage device is generally installed at a rear end of the firewall and protected by the private IP address that is invisible and inaccessible to the internet. Unless the firewall is set up specifically, network devices of another private network will be unable to know whether or not there is a network storage device connected to the private network via the Internet, and also unable to browse or access any file data of the network storage device. The network storage device is a standalone network device, which has not been connected to any I/O device such as a keyboard, a screen, and a mouse, so that a webpage browser (such as IE or Netscape) or other dedicated setup software running on the computer is required for setting up the network storage device remotely via the network. In general, a network storage device includes at least one hard disk which can be a logical disk or a redundant disk connected in a housing or the same as a traditional file server that connects a plurality of hard disks into a redundant array of independent disks (RAID), and the network storage device may adopt a file-based protocol such as the NFS protocol used by UNIX systems or the server message block (SMB) protocol used by Microsoft Windows Systems, but the network storage device does not limit a client from using any particular protocol for the communications.

In view of the description above, each network storage device in a private network of a new generation network system is connected to the Internet through a NAT router of the respective private network, so that when a client computer outside the private network wants to access file data from the network storage device via the Internet, an online communication channel cannot be established between the client computer and the network storage device, because the IP address of the private network of the network storage device is an unidentifiable private address, and thus a port cannot be opened at the NAT router of each private network.

Therefore, it is an important subject for device providers to design a network storage device that allows a client computer to penetrate a NAT router without any particular setup of the firewall and establish a barrier free connection channel with the network storage device in any private network through a public network, so that the client computer connected to the public network can access file data in the network storage device protected by the firewall.

### SUMMARY OF THE INVENTION

In view of the problems and shortcomings of the prior art, the inventor of the present invention based on years of experience in the related industry to conduct extensive researches and experiments, and finally invented a method and an apparatus of accessing a network storage device in private networks through the internet by using an instant messenger. In accordance with the invention, a client computer connected to the internet can penetrate firewalls and establish a barrier free connection channel with any network storage device in the private network that is also connected to internet through a NAT router, for successful data access.

An objective of the present invention is to provide a method of accessing a network storage device in different private networks through an instant messenger. The method is applied in a network system, and the network system comprises at least two private networks, the internet and an instant messenger server provided by ISP, wherein the instant messenger server is installed with a system having an instant messenger (such as MSN and SKYPE), a first private network includes at least one NAT router and at least one computer with a network interface, and a second private network includes at least one NAT router and at least one network storage device (such as a network-attached storage device, a web disk or a server installed with a web disk), and the computer and the network storage device are connected separately to the instant messenger server via the Internet. The method installs an instant messenger application program (such as MSN and SKYPE) on the computer and the network storage device, wherein the instant messenger application program installed on the network storage device is able to automatically register to the instant messenger server, communicate with other computers logined to the instant messenger server, receive requests of receiving or transmitting files being designated automatically, without having to be operated by a mouse, a keyboard, a monitor and a GUI interface, so that both computer and network storage device can use the instant messenger application program to connect to the Internet, and register to the instant messenger server provided by the Internet service provider (ISP). When the computer logins to the instant messenger server by using the instant messenger, the computer can find the network storage device registered to the instant messenger server and use the communication mechanism of the instant messenger to penetrate the NAT router of the respective private network, and communicate with the network storage device via the Internet, so that the computers can read/write data files of the network storage device through the instant messenger protocols.

Another objective of the present invention is to provide a network storage device, and the network storage device is installed with an instant messenger application program (such as MSN and SKYPE), and uses the instant messenger application program to connect to the Internet, and register to the an instant messenger server provided by an Internet service provider (ISP), so that the network storage device becomes a user of the instant messenger that can be used by other client computers. When a client computer uses the instant messenger to login to the instant messenger server, the client computer can find the network storage device that has been registered to the instant messenger server and use the communication mechanism of the instant messenger to penetrate firewalls installed in the NAT router of the respective private network and transmit control information to the network storage device, so that the network storage device can access the file data according to the control information.

To make it easier for our examiner to understand the shape, structure, design principle and performance of the present invention, we use preferred embodiments together with the attached drawings for the detailed description of the invention as follows:

### BRIEF DESCRIPTION OF THE DRAWINGS

FIG. 1 shows a schematic view of a structure of a network system in accordance with the present invention;

FIG. 2 is a flow chart of a method in accordance with a first preferred embodiment of the present invention; and

FIG. 3 is a schematic view of a hardware structure of a network storage device in accordance with a second preferred embodiment of the present invention.

### DETAILED DESCRIPTION OF THE PREFERRED EMBODIMENTS

Common communication protocols including H.323, SIP and MGCP are used by most instant messengers (such as MSN and SKYPE). For instance, the SIP protocol is a protocol developed by the IETF MMUSIC task force and also a communication standard provided for establishing, modifying and terminating various kinds of clients' interactive talks, and the clients' interactive talks include different multimedia interactive talks such as videos, instant messages and online games. Similarly, SIP and H.323 are used as the main signaling protocols for VoIP, and the objective of the SIP design is to provide an extended set similar to the call processing function of a public switched telephone network (PSTN) to implement operations including dialing, ringing, ring back tone or busy tone, except that they have different implementation methods and terminologies only. In general, SIP is a node-to-node protocol that simply requires a core network and leaves the processing work to an intelligent terminal node (such as a network terminal with installed software or hardware) connected to a network edge, and thus many functions of the SIP can be implemented in the terminal node. Such arrangement is very similar to the processing of a traditional PSTN and its core network equipments. The feature of the SIP resides on the IP network system that can work with other protocols to solve a portion of the communication session signaling problem. The session description protocol (SDP) in the SIP describes the details including the IP port and the encoder adopted in a data stream that is used in a session. The RTP is the actual carrier of the multimedia stream such as voices and videos. Although the RTP cannot pass through a NAT router, most SIP clients can pass through a NAT router, pass or use a RTP proxy server or pass through an unidentifiable NAT router of the SIP with the assistance of STUN.

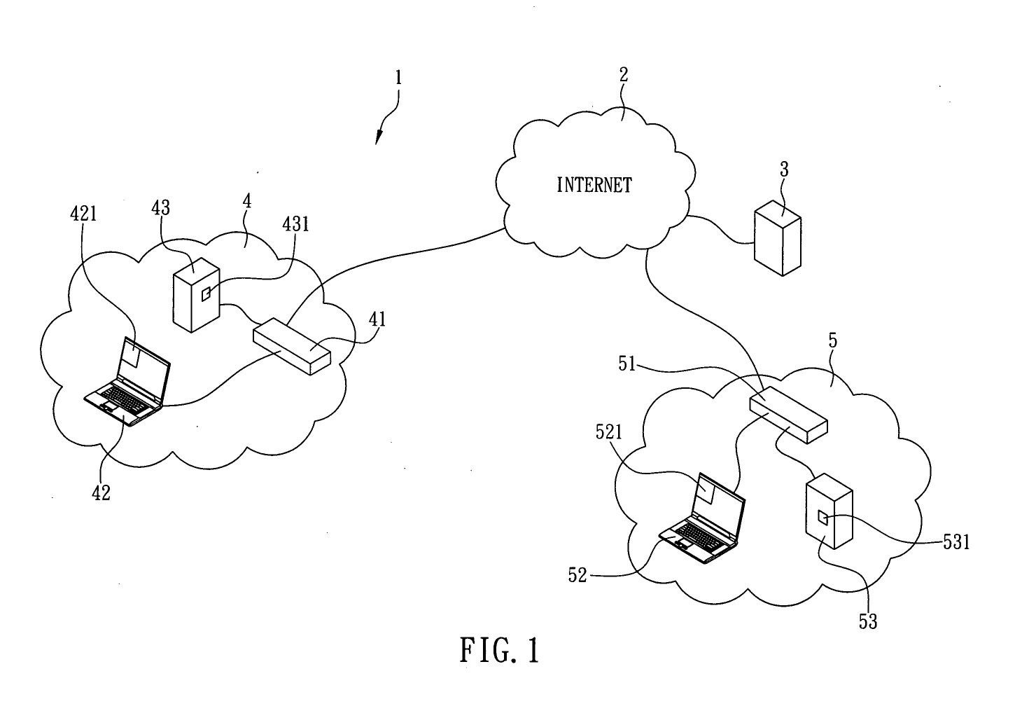

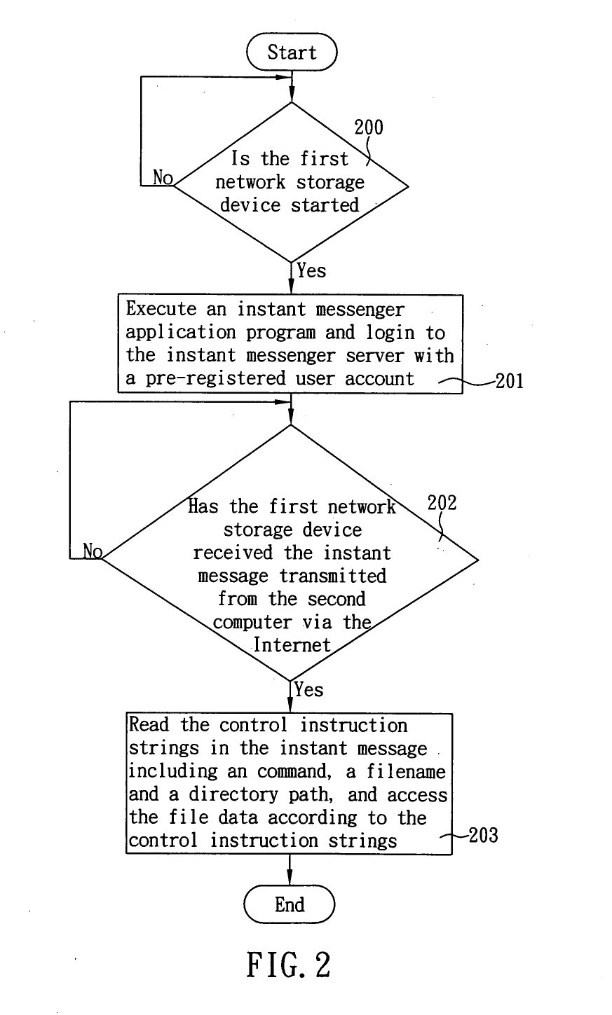

The inventor of the present invention based on the operating principle of the communication mechanism used by the aforementioned instant messengers to invent a method of accessing a network storage device in different private networks via an instant messenger. Referring to FIG. 1 for the first preferred embodiment of the present invention, the method is applied in a network system 1, and the network system 1 comprises the Internet 2, an instant messenger server 3 provided by an Internet service provider (ISP) and at least two private networks. In the first preferred embodiment, a first private network 4 and a second private network 5 are used for the illustration of the present invention, wherein the first private network 4 includes at least one network address translation (NAT) router and at least one computer having a network interface, and the second private network 5 includes at least one NAT router and at least one network storage device (such as a network-attached storage device, a web disk or a server installed with a web disk), but the invention is not limited to such arrangement only. In the first preferred embodiment, the first private network 4 includes a NAT router 41, a computer 42 having a network interface and a network storage device 43, and the second private network 5 includes a NAT router 51, a computer 52 having a network interface and a network storage device 53. Each computer 42, 52 and network storage device 43, 53 is connected to the Internet 2 through the NAT router 41, 51 of the respective private network 4, 5 and connected to the instant messenger server 3 via the Internet 2. In the method, an instant messenger application program 421, 431, 521, 531 (such as MSN) is installed on each computer 42, 52 and network storage device 43, 53 between the two private networks 4, 5, wherein the instant messenger application program 431, 531 installed on the network storage device 43, 53 is able to automatically login to the instant messenger server 3, communicate with other computers logined to the instant messenger server 3, receive messages as control instructions for receiving/transmitting files without having to be operated by a mouse, a keyboard, a monitor and a GUI interface. The computers 42, 52 have to register ISP accounts to the instant messenger server 3 for the network storage devices 43, 53, and set the registered instant messenger account into the network storage devices 43, 53. The instant messengers are free-download communication software provided by network software companies such as Microsoft. The computer 42 and the network storage device 53 use the instant messenger application programs 421, 531 in different private networks 4, 5 to connect to the Internet 2, and login to the instant messenger server 3 to execute instant voice/text communications and transmit files. If the computer 42 uses the instant messenger 421 to login to the instant messenger server 3, the computer 42 can find the network storage device 53 logined to the instant messenger server 3, use the communication mechanism of the instant messenger to penetrate the NAT routers 41, 51 of the private networks 4, 5 and communicate with the network storage device 53 via the Internet 2, so that computer 42 can access the files resided on the network storage device 53. In the first preferred embodiment of the present invention, each computer 42, 52 and network storage device 43, 53 needs to use the instant messenger application program 421, 431, 521, 531 to connect to the instant messenger server 3 via the Internet 2 according to the following procedure as shown in FIG. 2. Since each computer 42, 52 and network storage device 43, 53 executes the same procedure, only the first network storage device 43 of the first private network 4 is used to illustrate the invention for simplicity. The procedure comprises the following steps:

Step (200): Determine whether or not the first network storage device 43 is started; if yes, then go to Step (201), or else return to Step (200);

Step (201): Execute an instant messenger application program 431 and login to the instant messenger server 3 with a pre-registered user account, so that the first network storage device 43 becomes a user of the instant messenger that can be selected to start peer to peer communication by other client computers. If a second computer 52 of a second private network 5 uses the instant messenger application program 521 to login to the instant messenger server 3, the second computer 52 can find the first network storage device 43 that has been logined to the instant messenger server 3. If user of the second computer 52 wants to access files resided in the first network storage device 43, the user can select the first network storage device 43 to establish an instant message communication channel between the second computer 52 and the first network storage device 43, so that the user can key in control instruction strings, that may include command, filename and a directory path, in form of an instant message by using an I/O unit such as a screen, a keyboard and a mouse of the second computer 52, the instant message will first penetrate the second NAT router 51 of the respective private network, then further penetrate the first NAT router 41 of the via the Internet 2, and arrives to the first network storage device 43. In this embodiment, the control instruction strings may include but not limited to the following items (which can be added or deleted as needed):

a) cd: an instruction string for changing a working directory;

b) dir: an instruction string for showing filenames in the current directory;

c) get: an instruction string for getting a file;

d) put: an instruction string for saving a file; and

e) pwd: an instruction string for showing the path of the current working directory;

Step (202): Determine whether or not the first network storage device 43 has received the instant message transmitted from the second computer 52 via the Internet 2; if yes, then go to Step (203), or else return to Step (202);

Step (203): Read the control instruction strings in the instant message that may include an command, a filename and a directory path, and read the desired file data required by the second computer 52 out from a specified directory path of the first network storage device 43 according to the control instruction strings, and, and transmit the data to the second computer 52, or receive the file data sent from the second computer 52 and store the data into a specified directory path of the first network storage device 43.

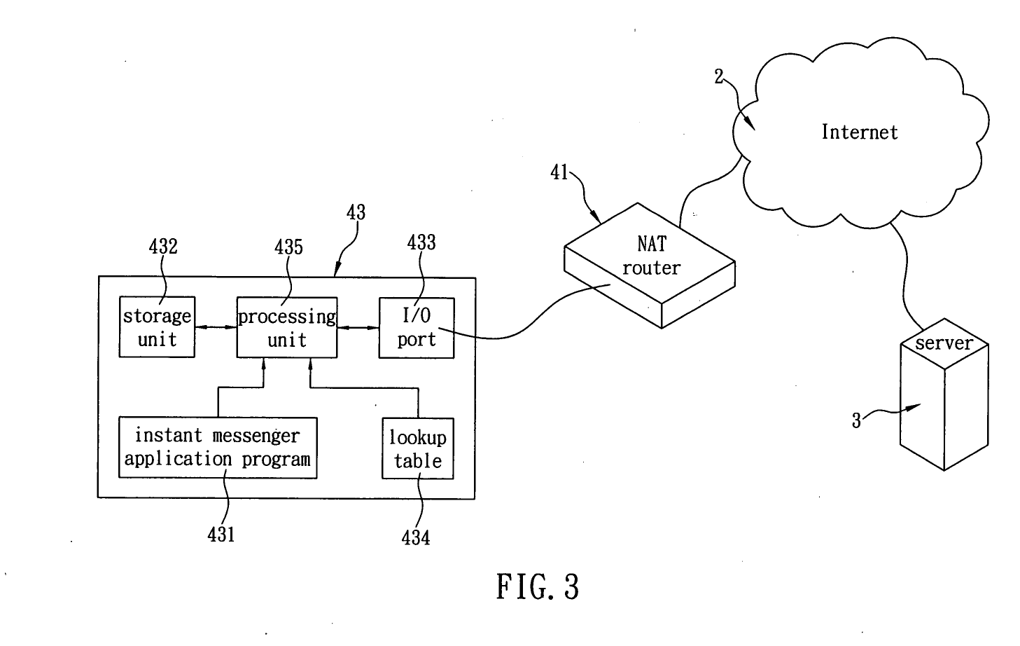

In a second preferred embodiment as shown in FIGS. 1 and 3, a network storage device 43 is provided and connected to a NAT router 41. The network storage device 43 comprises an instant messenger application program 431, such that the network storage device 43 can use the instant messenger application program 431 to connect to the Internet 2 and login to the instant messenger server 3, and become a user of the instant messenger that can be selected to communicate with other client computers logined to the instant messenger server 3; a storage unit 432, for storing a file data; an I/O port 433, connected to the NAT router 41, for receiving an instant message transmitted via the Internet 2; a control instruction string lookup table 434, for storing a control instruction string and its corresponding control procedure; and a processing unit 435, connected separately to the storage unit 432 and the I/O port 433, such that if the network storage device 43 is started, the network storage device 43 will execute the instant messenger application program 431 to connect to the Internet 2 and login to the instant messenger server 3, and the network storage device 43 will become a user of the instant messenger that can be selected to communicate with other computers logined to the instant messenger server 3. After the processing unit 435 has received the instant message from the Internet 2, the control instruction strings, that may include the command, the filename and the directory path, are read and a corresponding control procedure is looked up from the lookup table 434 according to the control instruction strings and is executed to read the desired file data required by the client computer out from a specified directory path of the storage unit 432, and send the file data to the client computer via the Internet 2, or receive a file data transmitted from the client computer and store the data into a specified directory path of the storage unit 432.

After the network storage device of the invention is started, the network storage device will automatically execute the instant messenger application program, login to an instant messenger server, so that the network storage device becomes a user of the instant messenger that can be selected to communicate with other computers logined to the instant messenger server. If a computer of a different private network uses the instant messenger to login to the instant messenger server, the computer will find the network storage device logined to the instant messenger server and can access data files on the network storage device. From the description above, users no longer need to set up the NAT router of the different private network first, but they can use the mechanism of the instant messenger to penetrate a NAT router installed in the respective private network for accessing data on the network storage device that is installed at a rear end of the NAT router in a different private network. The invention not effectively waives the setup of the network storage device only, but also maintains the security of the network storage device, overcomes the limitation of accessing data from different private networks, and provides data access/backup services on a private network at a different IP address.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method of accessing a network storage device from different private networks through an instant messenger, the method being applied in a network system, and the network system comprising at least two private networks, the Internet and an instant messenger server provided by an Internet service provider (ISP), wherein the instant messenger server comprises an instant messenger system, a first private network includes at least one network address translation router and at least one computer with a network interface, a second private network includes at least one network address translation router and at least one network storage device, and the computer and the network storage device are connected to the instant messenger server by the network address translation router of the respective private network via the Internet, and the method comprising the steps of:
the computer and the network storage device respectively starting an instant messenger application program installed thereon, wherein the instant messenger application program installed on the network storage device is able to login to the instant messenger server, communicate with other computers logined to the instant messenger server, receive requests for receiving/transmitting files automatically, without having to be operated by a mouse, a keyboard, a monitor and a GUI interface; the computer and network storage device respectively using the instant messenger application program to connect to the Internet, and logining to the instant messenger server;
the computer finding and selecting the network storage device logined to the instant messenger server;
the computer using the instant messenger to send out an instant message for penetrating a network address translation router of the respective private network, and arriving at the network storage device via the Internet;
the network storage device receiving the instant message, reading control instruction strings carried by the instant message; and
the network storage device accessing the file data or doing other operations according to the control instruction strings.

2. The method of claim 1, wherein the control instruction strings comprises an command, a filename and a directory path, and the command is used for specifying operation to be executed, and the filename represents the filename to be accessed by the network storage device, and the directory path is the directory path to be targeted on the network storage device.

3. The method of claim 2, wherein the network storage device is a network-attached storage device, a web disk or a server installed with a web disk.

4. A network storage device, comprising:
an instant messenger application program, for automatically logining to the network storage device to a instant messenger server on the Internet without having to be operated by a mouse, a keyboard, a monitor and a GUI interface, such that the network storage device becomes a user of the instant messenger that can be selected to be communicate with other computers logined to the instant messenger server;
a storage unit, for storing a file data;
an I/O port, coupled to a network address translation router, for receiving an instant message through the network address translation router from the Internet, or transmitting a file data stored in the storage unit to the Internet;
a control instruction string lookup table, for storing a command and a corresponding control procedure; and
a processing unit, coupled separately with the storage unit and the I/O port, for executing the instant messenger application program when the network storage device is started, such that the network storage device is connected to the Internet, and after the processing unit has received the instant message transmitted from the Internet, the processing unit reads control instruction strings carried in the instant message, and looks up a corresponding control procedure from the lookup table according to the command in the control instruction strings to execute the corresponding control procedure, to read a file data in the storage unit and transmits a data file to the Internet, or to receive a data file transmitted from the Internet and stores the file data in the storage unit.

5. The network storage device of claim 4, wherein the control instruction strings further comprises a filename and a directory path of the file data, and the filename represents a filename of a file data accessed by the storage unit, and the directory path is a directory path of a filename of a file data accessed by the storage unit.

6. The network storage device of claim 5, wherein the instant message is a packet produced according to the communication protocol of the instant messenger.

7. The network storage device of claim 6, wherein the network storage device is a network-attached storage device, a web disk or a server installed with a web disk.
